(19) United States
(12) Patent Application Publication
(10) Pub. No.: US 2024/0118914 A1
(43) Pub. Date: Apr. 11, 2024

(54) ACCELERATED VIRTUAL PASSTHROUGH I/O DEVICE PERFORMANCE

(71) Applicants: Chuanxiao Dong, Beijing (CN); I-Chun Fang, San Jose, CA (US); Yanting Jiang, Shanghai (CN)

(72) Inventors: Chuanxiao Dong, Beijing (CN); I-Chun Fang, San Jose, CA (US); Yanting Jiang, Shanghai (CN)

(21) Appl. No.: 18/389,630

(22) Filed: Dec. 19, 2023

(30) Foreign Application Priority Data
Nov. 28, 2023 (WO) PCT/CN2023/134735

(51) Int. Cl. G06F 9/455

(52) U.S. Cl. CPC G06F 9/45558; G06F 2009/45579; G06F 2009/45583

(57) ABSTRACT

An L2 virtual machine (VM) operating in a trust domain invokes a memory operation involving a virtual I/O device passed through from an L1 VM. Invocation of the memory operation causes an L2 virtual I/O device driver to make a hypercall to a trust domain management module. The hypercall comprises a memory-mapped I/O (MMIO) address of the virtual I/O device as seen by the L2 VM (L2 MMIO address), which matches the MMIO address of the virtual I/O device as seen by the L1 VM. The module passes hypercall information to an LO hypervisor, which forwards the information to an emulator operating in LO user space that emulates the back end of the virtual I/O device operating on the L1 VM. The emulator determines an emulated software response based on the L2 MMIO address and the memory operation is carried out.

### CROSS-REFERENCE TO RELATED APPLICATIONS

This application claims the benefit of priority under 35 U.S.C. § 119(b) to PCT International Application Serial No. PCT/CN2023/134735 filed on Nov. 28, 2023, entitled “MEMORY-MAPPED INPUT/OUTPUT ACCELERATION FOR VIRTUAL INPUT/OUTPUT DEVICES.” The disclosure of the prior application is considered part of and is hereby incorporated by reference in its entirety in the disclosure of this application.

### BACKGROUND

A bare-metal (type 1) or native (type 2) hypervisor operating on a computing system can allow the computing machine to function as a host for a first virtual machine that operates on the computing system. The first virtual machine can, in turn, function as a host for a second virtual machine that operates on the first virtual machine. The first virtual machine can be considered a guest of the host computing system and the second virtual machine can be considered a guest of the first virtual machine. Multiple second virtual machines that are partitioned from each other can operate on the first virtual machine.

### BRIEF DESCRIPTION OF THE DRAWINGS

FIG. 1 illustrates a first example computing environment comprising multiple virtualization levels.

FIG. 2 illustrates a second example computing environment comprising multiple virtualization levels.

FIG. 3 is an example method of programming an MMIO BAR of an L2 virtual passthrough I/O device prior to startup of an L2 virtual machine.

FIG. 4 is an example flowchart illustrating the programming of an MMIO BAR of an L2 virtual passthrough PCIe device by a BIOS of an L2 virtual machine (L2 BIOS) to be operated in a trust domain.

FIG. 5 is an example flowchart for determining the software response based on the L2 MMIO address for an L2 virtio passthrough PCIe device in an L2 virtual machine operating in a trust domain and utilizing identity-mapped MMIO BAR addresses.

FIG. 6 is an example method of determining an emulated software response based on an L2 MMIO address.

FIG. 7 is a block diagram of an example computing system in which technologies described herein may be implemented.

FIG. 8 is a block diagram of an example processor unit 800 to execute computer-executable instructions as part of implementing technologies described herein.

### DETAILED DESCRIPTION

On a computing system acting as a host machine (host) for a first virtual machine, the first virtual machine can function as a host for multiple second virtual machines. The first virtual machine can be considered a guest machine (guest) operating on the host computing system and the second virtual machines can be considered guest machines operating on the first virtual machine. The second virtual machines can be partitioned from each other, which means that the individual second virtual machines have portions of computing system resources (e.g., processors, input/output, memory) dedicated to them. A second virtual machine partitioned from other second virtual machines cannot “see” the computing system resources dedicated to the other second virtual machines. A hypervisor running on the first virtual machine can be responsible for assigning and managing the computing system resources dedicated to the individual partitioned second virtual machines.

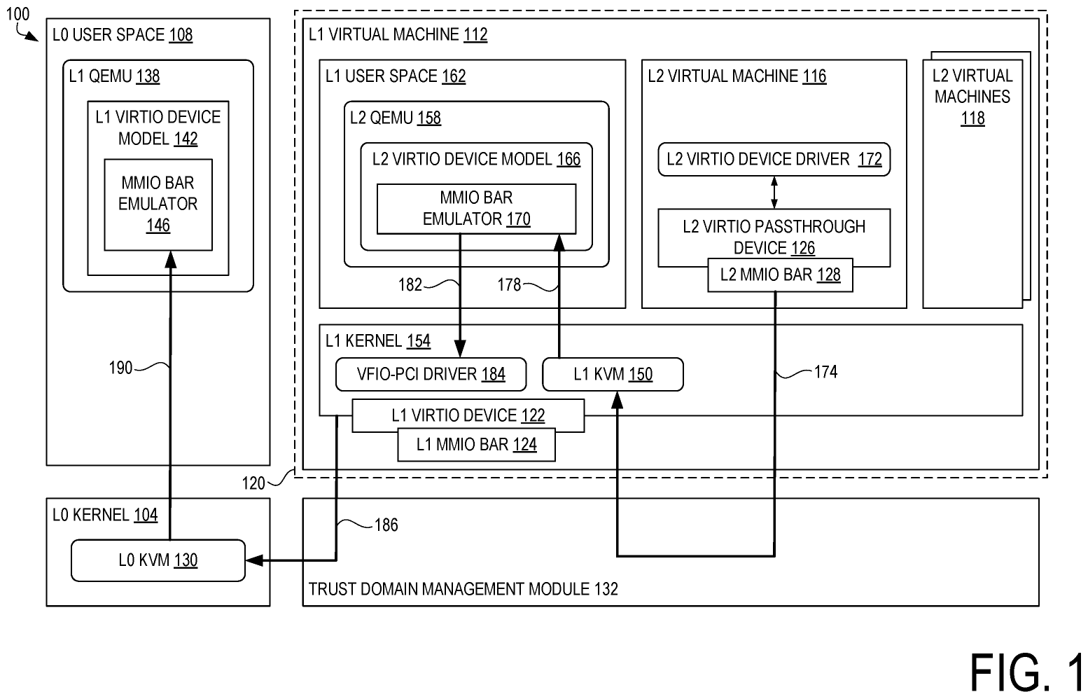

FIG. 1 illustrates a first example computing environment comprising multiple virtualization levels. The computing environment 100 operates on a computing system, which can be any computing system described or referenced herein, such as a mobile computing device (e.g., laptop, tablet, smartphone), server, workstation, or rack-level computing solution (e.g., blade, tray, or sled computing system), or any other computing system. The computing environment 100 comprises a level 1 virtual machine hosting multiple level 2 virtual machines. As used herein, the terms level zero (L0), level one (L1), and level two (L2) refer to a virtualization level within a computing environment, with L0 components operating at the lowest virtualization level. For example, an L0 component operates either directly on the computing system's hardware platform (e.g., processors, memory, I/O resources) or within an operating system operating directly on (is hosted by) the computing system's hardware platform, an L1 component operates on (is hosted by) an L0 component, and an L2 component operates on (is hosted by) an L1 virtual machine.

The computing environment 100 comprises an L0 kernel 104, an L0 user space 108, an L1 virtual machine 112, and L2 virtual machines 116 and 118. The L1 virtual machine 112 is managed at least in part by an L0 kernel-based virtual machine (L0 KVM 130) that allows the L0 kernel 104 to operate as a hypervisor, and the L2 virtual machines 116 and 118 are managed by an L1 KVM 150. L2 virtual machine 116 is partitioned from the L2 virtual machines 118.

The computing environment 100 is capable of supporting trust domains. A trust domain can help protect data and applications from unauthorized access, by, for example, applications and operating systems operating outside of the trust domain. The trust domains can operate within a reserved portion of memory (which can be one or more contiguous portions of memory) of the computing device, which can be referred to as private memory for the trust domain. The contents of the reserved portion of memory can be encrypted. A trust domain can be enabled by a trusted execution environment, which can be a secure area of a processor. The trusted execution environment can perform encryption and decryption of the reserved portion of memory dedicated to trust domains. Referring to FIG. 1, the L1 virtual machine 112 and L2 virtual machines 116 and 118 operate within a trust domain 120. A trust domain management module 132 ensures that private memory accesses made by components operating within the trust domain are made into the portion of memory reserved for trust domains. In some embodiments, the trust domain 120 can be enabled by Intel® Trust Execution Technology (Intel® TXT)-enabled processor and the trust domain management module 132 can be an Intel® Trust Domain Extensions (Intel® TDX) module that utilizes a Secure Arbitration Mode (SEAM) of an Intel® TDX-enabled processor. This Intel® TDX module, which can be referred to as a SEAM module, can build, tear down, and start execution of trust domain virtual machines. The partitioned L2 virtual machines 116 and 118 share the same guest physical address space as the L1 virtual machine, which means that the L1 and L2 guest physical addresses (GPA) and the memory space used by the virtual machine spaces are the same. This can simplify GPA address translation in the trust domain management module. However, guest physical address spaces for memory-mapped I/O (MMIO) devices are not partitioned.

The L1 virtual machine 112 comprises L1 virtio device 122 (a “virtio device” being a virtual I/O device that is compliant with the virtio virtualization standard) that is passed through to the L2 virtual machine 116 as L2 virtio passthrough device 126. The I/O device associated with the L1 virtio device 122 can be any I/O device described or referenced herein (e.g., hard drive, network interface card (NIC)), or any other I/O device. The L1 virtio device 122 is passed through from the L1 virtual machine 112 to the L2 virtual machine 116 via the VFIO (Virtual Function I/O) kernel framework. The I/O device represented by the L1 virtio device 122 and the L2 virtio passthrough device 126 is also a PCIe device (a device compliant with the Peripheral Component Interconnection Express standard). A VFIO-PCI driver 184 located in the L1 kernel 154 communicates with the L1 virtio device 122. Each PCIe device has one or more base address registers (BARs) that each store a starting address and size of a portion of the computing device memory space mapped to the PCIe device. These BARs can be referred to as MMIO BARs (memory-mapped I/O BARs). An address stored in an MMIO BAR (MMIO BAR address) of an I/O device can refer to an address of physical memory of the computing device and an MMIO BAR address of a virtual device (such as L1 virtio device 122 and L2 virtio passthrough device 126) can refer to a virtual memory address. L1 MMIO BAR 124 is a base address register of L1 virtio device 122, as seen by the L1 virtual machine 112, and L2 MMIO BAR 128 is a base address register of L2 virtio passthrough device 126, as seen by the L2 virtual machine 116.

An instance of the QEMU emulation software (L1 QEMU 138) operating in L0 user space 108 comprises a virtio back-end device model (L1 virtio device model 142) that emulates the back end of the L1 virtio device 122. The virtio device model 142 comprises an MMIO BAR emulator 146 that emulates the MMIO BARs of the L1 virtio device 122. A kernel-based hypervisor (L1 KVM 150) operating in an L1 kernel 154 is involved in the creation and management of the L2 virtual machine 116. A QEMU operating in L1 user space 162 (L2 QEMU 158) comprises a virtio back-end device model (L2 virtio device model 166) that emulates the back end of the L2 virtio passthrough device 126. The L2 virtio device model 166 comprises an MMIO BAR emulator 170 that emulates MMIO BARs for the L2 virtio passthrough device 126. An L2 virtio device driver 172 allows for an operating system and applications operating in the L2 virtual machine 116 to interface with the L2 virtio passthrough device 126.

In passthrough technology, a hypervisor can pass through a physical I/O device from a host computing system to a guest and provide the guest machine direct access to the physical I/O device's MMIO BARs without causing any “VM exits” (where the execution context of the computing system changes from the guest machine to a hypervisor, host operating system, or other software modules responsible for managing the virtual machine). This can allow for improved I/O device performance over embodiments where the I/O device is emulated on the host machine, and access to an MMIO BAR by the virtual machine causes a VM exit to the hypervisor, which then calls an I/O device emulator to handle the MMIO BAR access.

Direct access by a guest device to a physical device's MMIO BARs can be enabled by mappings available to the hypervisor that allow for the translation of an address within the guest physical address to an address in the host physical address (HPA, the memory space of by the host machine). In some embodiments, this mapping is implemented with extended page tables (EPTs). An MMIO BAR of a virtual device can be assigned by the virtual machine BIOS (Basic I/O System) during startup of the virtual machine. If the passthrough device is a PCIe device, the assigned MMIO BAR address can be determined based on the I/O device's PCIe memory window with the guest physical address space and is likely a different address than the physical device's MMIO BAR address. The hypervisor stores the mapping of the assigned MMIO BAR address in the guest physical address space for the passthrough device to the MMIO BAR address in the host physical address for use during operation of the virtual machine.

As can be seen in FIG. 1, passthrough technology can also be used to pass through a virtual I/O device from an L1 virtual machine to an L2 virtual machine operating on the L1 virtual machine (L1 virtio device 122 being passed through from L1 virtual machine 112 to L2 virtual machine 116 as L2 virtio passthrough device 126). As the MMIO BAR addresses of the L1 virtio device 122 correspond to a location in virtual memory, and not physical memory, there is no valid guest physical address to host physical address mapping in L1 KVM 150. Thus, accessing the L2 MMIO BAR 128 of the L2 virtio passthrough device 126 by the L2 virtio device driver 172 can result in a VM exit. Access to the MMIO BAR 128 of the virtio passthrough device 126 by the L2 virtio device driver 172 can be handled as follows.

First, with reference to arrow 174 in FIG. 1, the L2 virtio device driver 172 accessing the L2 MMIO BAR 128 triggers a VM exit to the trust domain management module 132. The trust domain management module 132 receives information corresponding to the access of the MMIO BAR 128 by the L2 virtio device driver 172. This information can correspond to a read, write, or other memory operation involving the L2 virtio passthrough device 126, along with the L2 MMIO address (an MMIO address within the memory range specified by the L2 MMIO BAR 128). The trust domain management module 132 identifies the information as coming from an L2 virtual machine and forwards the information to the L1 KVM 150 to resolve the L2 MMIO BAR address. The trust domain management module 132 transfers control to the L1 KVM 150 via a VM exit. Second, with reference to arrow 178, the L1 KVM 150 identifies the information received from the trust domain management module 132 as pertaining to an L2 MMIO BAR access and transfers control to the L2 QEMU 158 to emulate the L2 MMIO BAR 128 to determine an L1 host physical address (which is a virtual address, as the host of the L2 guest is an L1 virtual machine) from the L2 guest physical address (L2 MMIO address). Third, with reference to arrow 182, to determine the L1 host physical address associated with the L2 virtio device memory access, the L2 QEMU 158 calls the L1 kernel 154. The L1 kernel 154 accesses the VFIO-PCI kernel driver 184 to determine the L1 host physical address. In turn, the VFIO-PCI kernel driver 184 accesses the L1 MMIO BAR 124 of the L1 virtio device 122. Fourth, with reference to arrow 186, accessing the L1 MMIO BAR 124 of the virtio device 122 causes a VM exit to the trust domain management module 132, with the L1 MMIO address (an MMIO address within the memory range specified by the L1 MMIO BAR 124) being passed to the trust domain management module 132. The trust domain management module 132 identifies this VM exit as coming from an L1 virtual machine and passes the L1 MMIO address to the L0 hypervisor (L0 KVM 130). Fifth, with reference to arrow 190, the L0 KVM 130 sends the L1 MMIO address to the L1 QEMU 138, where the L1 MMIO BAR 124 is emulated by the MMIO BAR emulator 146. The MMIO BAR emulator 146 emulates the software response to the memory operation based on the MMIO address for the I/O device represented by the L1 virtio device 122 and the L2 virtio passthrough device 126 based on the L1 MMIO address. Thus, the VM exit caused by the L2 virtio device driver 172 accessing the L2 MMIO BAR 128 of the L2 virtio passthrough device 126 is handled at L0, but only after the VM exit is first routed to the L1 virtual machine 112.

Described herein are technologies that allow for the acceleration of virtual passthrough I/O device performance. Accelerated virtual passthrough I/O device performance is enabled via the direct handling of L2 MMIO BAR accesses in L0 when accessing virtual I/O devices from an L2 virtual machine, bypassing L2 MMIO BAR emulation by an L1 virtual machine. This shortens the MMIO emulation path and can improve the performance of L2 guests, such as those operating in a trusted environment on CSP (cloud solution provider)-provided computing infrastructures, such as infrastructures including Intel® TXT-enabled computing systems. The direct handling of L2 MMIO BAR accesses can be enabled by the L2 BIOS (Basic I/O System), L2 virtual I/O device driver, and the software module responsible for handling L2 MMIO BAR accesses (e.g., trust domain management module 132). In response to receiving information indicating a memory operation involving a virtual I/O device, the software module routes a VM exit (which includes an L2 MMIO address) to an L0 hypervisor, bypassing the L1 virtual machine. In trust domain embodiments operating on Intel® TXT-enabled processors, the software module can be a SEAM module and the L2 virtio device driver 172 can pass the information indicating the memory operation involving a virtual I/O device, which includes the L2 MMIO address, via a TDVMCALL operation.

The L0 hypervisor receiving the VM exit needs to know which virtual I/O device model in L0 user space to call. That is, the L0 hypervisor needs to know which virtual I/O device model the L2 MMIO address received in the VM exit corresponds to. In existing embodiments, the L2 MMIO BAR address is allocated by L2 BIOS, and the L2 virtual machine is managed by the L1 hypervisor, so the L0 hypervisor does not have the mapping between an L2 MMIO BAR address and an L1 MMIO BAR address. This issue is addressed by the use of identity-mapped MMIO BAR addresses, in which the L2 MMIO BAR of an L2 virtio passthrough device is the same as the L1 MMIO BAR for the corresponding L1 virtio device. Thus, when the L0 hypervisor receives an L2 MMIO address, it is able to recognize which virtual I/O device model to use to generate a software response to the memory operation.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. Furthermore, the terms “comprising,” “including,” “having,” and the like, as used with respect to embodiments of the present disclosure, are synonymous.

Reference is now made to the drawings, wherein similar or same numbers may be used to designate same or similar parts in different figures. The use of similar or same numbers in different figures does not mean all figures including similar or same numbers constitute a single or same embodiment Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

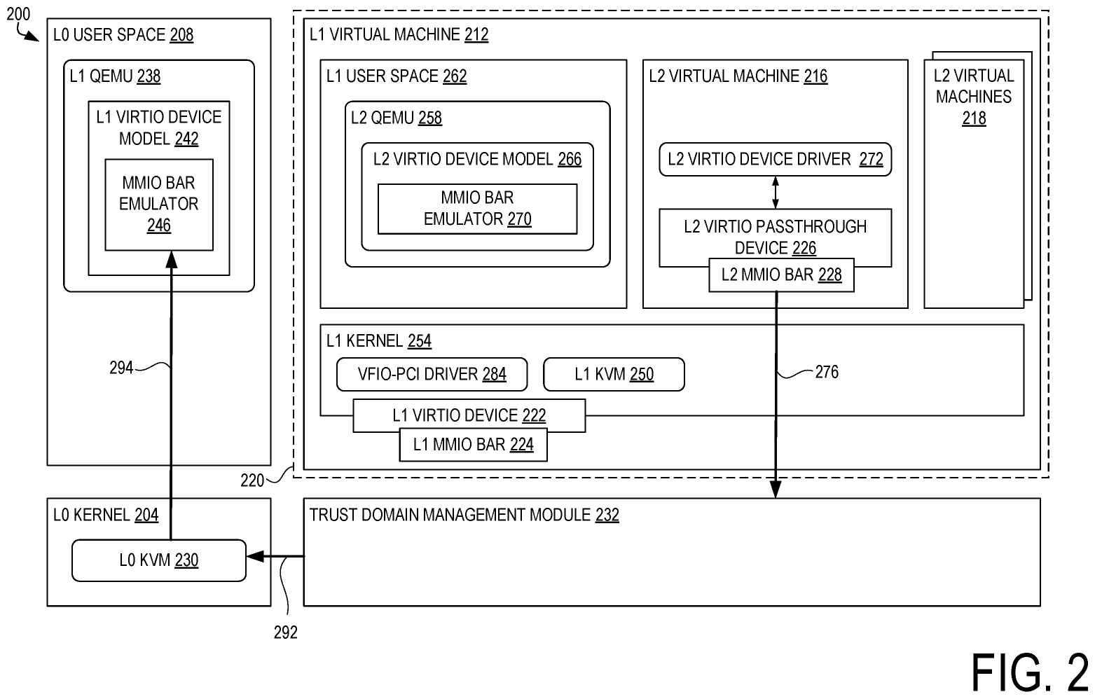

FIG. 2 illustrates a second example computing environment comprising multiple virtualization levels. The computing environment 200 has the same components as the computing environment 100 with components in the computing environment 200 performing as their similarly-numbered components (e.g., 116 and 216) as described above, with at least the following exceptions. First, the L2 virtio device driver 272 is configured to make a hypercall to the trust domain management module 232 in response to an operating system or application executing on the L2 virtual machine 216 performing a memory operation involving the L2 virtio passthrough device 226. Second, the trust domain management module 232 is configured to route the hypercall from the L2 virtual machine 216 to the L0 hypervisor (L0 KVM 230) instead of the L1 hypervisor (L1 KVM 250). Third, the L2 BIOS (not shown in FIG. 2) and the L2 QEMU 258 are configured such that the addresses of the L2 MMIO BARs are identity-mapped. That is, as will be discussed in more detail below, upon completion of startup of the L2 virtual machine 216, the address of the L2 MMIO BAR 228 is the same as the address of the L1 MMIO BAR 224.

The computing environment 200 handles an application or operating system on the L2 virtual machine 216 invoking a memory operation involving the L2 virtio passthrough device 226 as follows. First, as illustrated by arrow 276, virtio device driver 272 accesses the L2 MMIO BAR 228 and the trust domain management module 232 receives information indicating the memory operation involving the L2 virtio passthrough device 226, such as write data if the memory operation is a write operation, along with an L2 MMIO address. The L2 MMIO BAR 228 address, as will be discussed in greater detail below, is set to the address of the L1 MMIO BAR 224. Second, as illustrated by arrow 292, the trust domain management module 232 passes the information to the L0 hypervisor (L0 KVM 230). Third, as illustrated by arrow 294, the L0 hypervisor passes the information to the L1 QEMU 238, which emulates the back end of the L1 virtio device 222 and generates the software response to the memory operation based on the L2 MMIO address. After generation of the software response corresponding to the L2 MMIO address, the memory operation can be completed. For example, if the memory operation is a write operation, write data passed from the L2 virtio device driver 272 to the L0 hypervisor can be written to the virtual I/O device. If the memory is a read operation, data read from the L1 virtual device model can be passed from the L0 hypervisor to the L2 virtio device driver 272.

The information passed to the trust domain management module 232 can be passed by a hypercall made by the L2 virtual machine 216. Specifically, the L2 virtio device driver 272 makes a hypercall to the trust domain management module 232 as part of the operating system or any applications executing on the L2 virtual machine 216 performing a memory operation involving the L2 virtio passthrough device 226. The input parameters to the hypercall are an L2 MMIO address and write data if the memory access is part of a write operation.

In embodiments where the computing environment 200 operates on a computing device comprising an Intel® TXT-enabled processor, the hypercall can be a TDVMCALL operation and the trust domain management module 232 can be a SEAM module. An L2 MMIO address and write data, as appropriate, can be supplied as input parameters to the TDVMCALL. In these embodiments, the SEAM module is configured to route TDVMCALLs from the L2 virtual machine 216 to the L0 hypervisor with the TDVMCALL input parameters.

Identity-mapped MMIO BAR addresses are enabled by the L2 BIOS and the L2 QEMU 258. MMIO BAR addresses of a virtual I/O device are usually programmed by BIOS during startup of the virtual machine. In embodiments where the virtual I/O device is a PCIe virtio device, MMIO BAR addresses are determined by the BIOS according to the PCIe memory window. The BIOS can pick an unused address in the PCIe memory window as an MMIO BAR address. The assigned MMIO BAR addresses are programmed into the virtio device's PCIe configuration base address registers.

As the PCIe configuration space of the front-end L2 virtio passthrough device 226 passthrough device's PCI configuration space is emulated by the L2 QEMU 258, programming the address of the L2 MMIO BAR 228 during L2 virtual machine startup traps into the L2 QEMU 258 and the programmed L2 MMIO BAR addresses are recorded in the virtual PCIe configuration memory. To make sure that the front-end L2 virtio passthrough device 226 uses the same MMIO BAR addresses as the back-end L2 virtio device 222, the L2 QEMU 258 initializes the virtual PCIe configuration base address register before startup of the L2 virtual machine 216 with the MMIO BAR address of the L1 virtio device 222. The L2 BIOS can be configured to skip assigning an MMIO BAR address of the L2 virtio passthrough device 226 if it sees the MMIO BAR address is already programmed with a non-zero value.

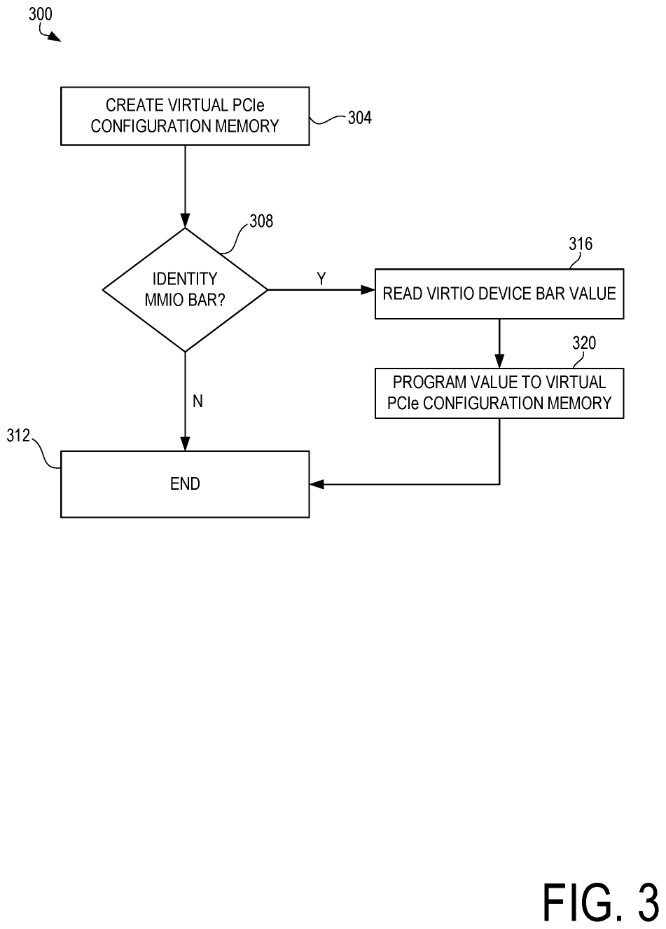

FIG. 3 is an example method of programming an MMIO BAR of an L2 virtual passthrough I/O device before startup of the L2 virtual machine that will comprise the L2 virtual passthrough I/O device. The method 300 can be performed by an emulator that emulates the back end of an L2 PCIe virtio passthrough device (e.g., L2 QEMU 258 emulating the back end of L2 virtio passthrough device 226). At 304, a virtual PCIe configuration memory is created for the L2 virtio passthrough I/O device. The virtual PCIe configuration memory stores the MMIO BAR address of the virtual I/O device, along with other configuration parameters for the L2 virtio passthrough device. All of the MMIO BAR addresses are initialized to zero. At 308, if the MMIO BAR for the L2 virtio passthrough device is not to be identity mapped, the method 300 completes at 312. If the MMIO BAR for the L2 virtio passthrough device is to be identity mapped, the method proceeds to 316. At 316, the MMIO BAR address of the L1 virtual I/O device being passed through to the L2 virtual machine is read from the L1 virtual machine. In some embodiments, where the virtual I/O device is a virtio PCIe device, the addresses of the MMIO BAR of the L1 virtual I/O device is read from the virtual PCIe configuration space for the L1 virtio I/O device. In some embodiments, this BAR address can be read by a VFIO-PCI kernel driver (e.g., VFIO-PCI driver 284 in the L1 kernel 254). At 320, the MMIO BAR address of the L1 virtual I/O device is written to the PCIe configuration memory for the L2 virtio passthrough I/O device, and the method 300 completes at 312. Thus, method 300 allows for the MMIO BAR address for an L2 virtio passthrough I/O device to be assigned before the startup of an L2 virtual machine that will comprise the L2 virtio passthrough I/O device. By assigning the MMIO BAR address of an L2 virtual I/O device to the MMIO BAR address of the corresponding L1 virtual I/O device, the MMIO BAR address for the L2 virtual I/O device can be considered to be identity-mapped. That is, utilizing the technologies disclosed herein, an MMIO BAR address of an L2 virtual passthrough I/O device can be resolved at the L0 level without having to involve an L1 emulator that emulates the virtual I/O device. Identity-mapped L2 MMIO BARs can be utilized for L2 virtual passthrough I/O devices implemented in partitioned L2 virtual machines. That is, identity-mapped L2 MMIO BARs allow for an L0 hypervisor to determine which virtual I/O device from among a plurality of I/O devices represented by a plurality of L2 virtual passthrough devices implemented in a plurality of L2 virtual machines is associated with an L2 MMIO address received from a trust domain management module.

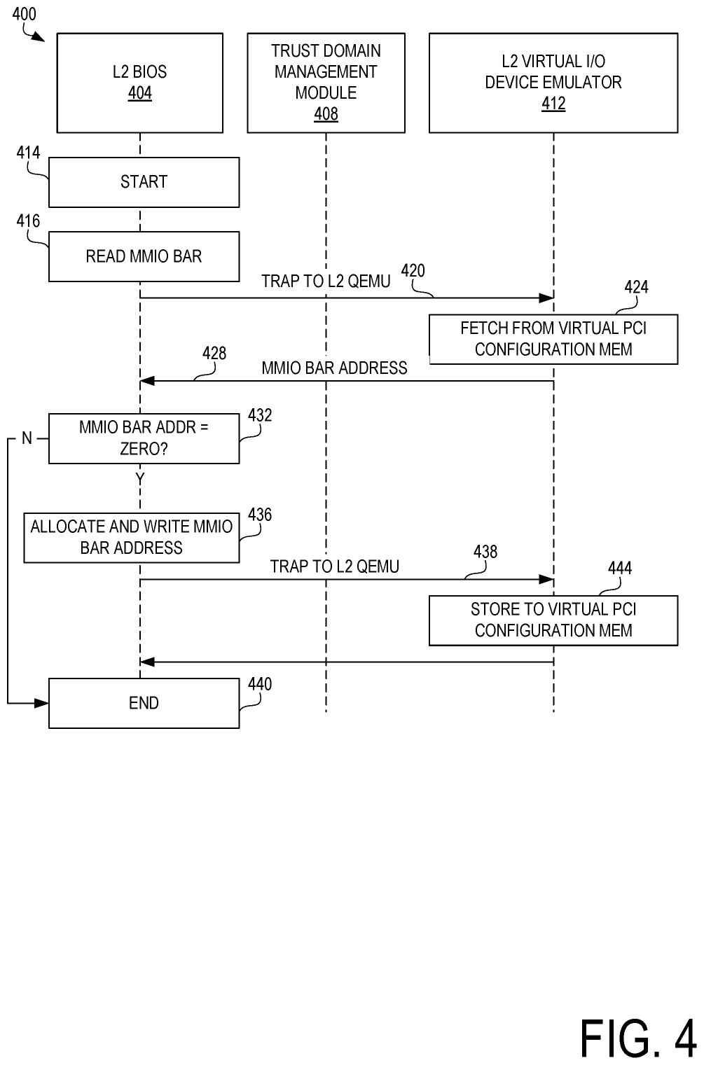

FIG. 4 is an example flowchart illustrating the programming of an MMIO BAR of an L2 virtual passthrough PCIe device by a BIOS of an L2 virtual machine (L2 BIOS) to be operated in a trust domain. The flowchart 400 comprises three lanes, one for an L2 BIOS 404, one for a trust domain management module 408, and one for an L2 emulator for the L2 virtio passthrough PCIe device (e.g., L2 virtual I/O device emulator 412). The process illustrated by flowchart 400 starts at 414. At 416, the L2 BIOS 404 reads an MMIO BAR of the L2 virtual passthrough PCIe device. At 420, the trust domain management module 408, which manages memory access operations made by the L2 BIOS, traps the MMIO BAR read operation and sends it to the L2 virtual I/O device emulator 412. At 424, the L2 virtual I/O device emulator 412 reads the L2 MMIO BAR address from virtual PCIe configuration memory and, at 428, the MMIO BAR address is returned to the L2 BIOS 404. At 432, the L2 BIOS 404 checks to see if the MMIO BAR address is non-zero. If the MMIO BAR address is zero, at 436, the L2 BIOS 404 allocates an address for the MMIO BAR address for the L2 virtio passthrough PCIe device and writes the address to the MMIO BAR. At 438, the trust domain management module 408 traps the MMIO BAR write operation and the MMIO BAR write operation is sent to the L2 virtual I/O device emulator 412 for handling. The MMIO BAR address is written to the virtual PCIe configuration memory at 444 and the flowchart ends at 440. If the MMIO BAR address checked at 430 is not zero, due to, for example, the MMIO BAR having been programmed prior to startup of the L2 virtual machine with an MMIO BAR address for an L1 virtual I/O device, the process ends at 440. Thus, flowchart 400 illustrates a process by which an L2 BIOS can skip programming the MMIO BAR of a virtual passthrough I/O device and implement an identity-mapped MMIO BAR address for an L2 virtual passthrough I/O device.

In some embodiments, the L2 virtual I/O device emulator 412 can comprise an L2 QEMU (e.g., L2 QEMU 258). In embodiments where the trust domain is enabled by an Intel® TDX-enabled processor, the trust domain management module 408 can be a SEAM module. Although the flowchart 400 illustrates the programming of an MMIO BAR for a PCIe device, in other embodiments, the MMIO BAR for non-PCIe I/O devices can be programmed according to the flowchart 400.

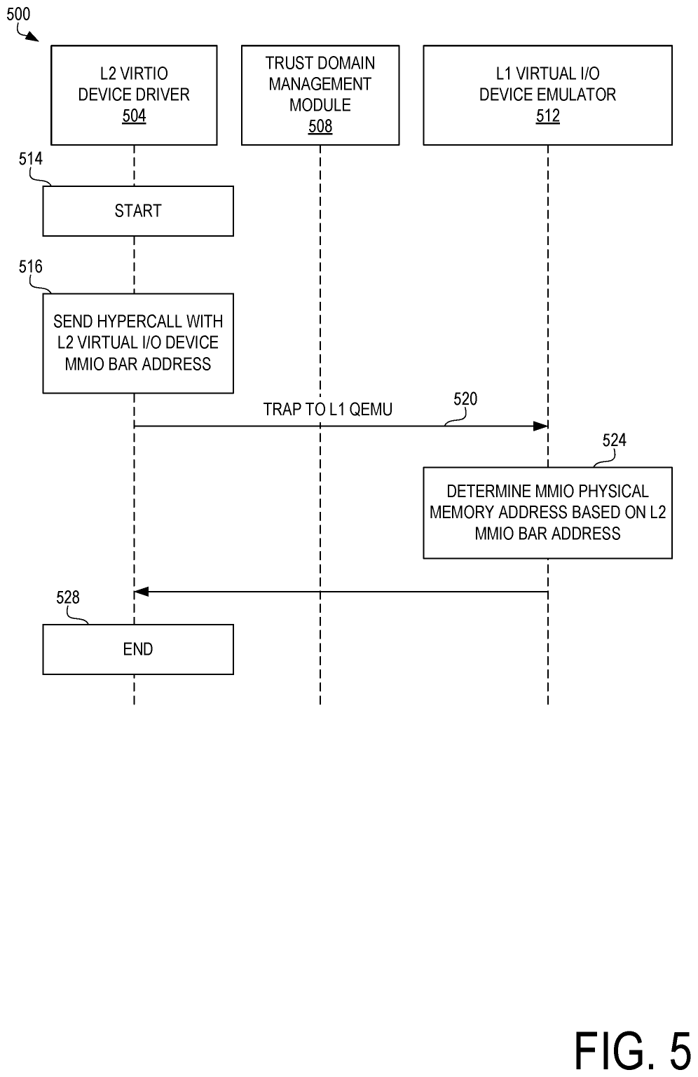

FIG. 5 is an example flowchart for determining a software response corresponding to the L2 MMIO BAR access for an L2 virtio passthrough PCIe device in an L2 virtual machine operating in a trust domain and utilizing identity-mapped MMIO BAR addresses. The flowchart 500 comprises three lanes, one for an L2 virtio device driver 504, one for a trust domain management module 508, and one for an L1 virtual I/O device emulator 512. The process illustrated by flowchart 500 starts at 514. At 516, the L2 virtio device driver 504 makes a hypercall to the trust domain management module 508. The hypercall comprises information pertaining to a memory operation involving the L2 virtual I/O device associated with the L2 virtio device driver 504, including an MMIO address of the L2 virtual passthrough I/O device. As the MMIO BAR address of the L2 virtual passthrough I/O device is an identity-mapped MMIO BAR address, it matches an MMIO address of the corresponding L1 virtual I/O device. At 520, the trust domain management module 508 sends the hypercall to the L1 virtual I/O device emulator 512 (via an L0 hypervisor). At 524, the L1 virtual I/O device emulator 512 determines the software response corresponding to this access to the L2 virtual I/O device MMIO address. The process ends at 528. Thus, flowchart 500 illustrates a flow by which an emulated I/O response is determined from an L2 MMIO address for an L2 virtual passthrough I/O device without involving an emulator for the L2 virtio passthrough I/O device operating in L1 user space.

In some embodiments of the process illustrated by flowchart 500, the L1 virtual I/O device emulator 512 can comprise an L1 QEMU (e.g., L1 QEMU 238). In embodiments where the trust domain is enabled by an Intel® TDX-enabled processor, the trust domain management module 508 can be a SEAM module and the hypercall at 516 can be a TDVMCALL. Although the flowchart 500 illustrates the programming of a BAR for a PCIe device, in other embodiments, the BAR for non-PCIe I/O devices can be programmed according to the flowchart 500.

In one implementation of the technologies disclosed herein, the throughputs of random read and write operations to a virtio passthrough device implemented in an L2 virtual machine operating in a trust domain and utilizing identity-mapped L2 MMIO BARs, were measured to be 87% and 20% greater, respectively, than an implementation of a virtio passthrough device implemented in an L2 virtual machine operating in a trust domain in which determination of emulated software responses from L2 MMIO addresses involved emulators for the L2 virtio passthrough device operating in L1 user space.

In other embodiments of a computing environment in which L2 MMIO BAR addresses are identity-mapped and a software response is determined from an L2 MMIO address without utilizing an L1 emulator (or any other L1 component) to translate the L2 MMIO address to an L1 MMIO address, the L1 and L2 virtual machines do not operate in a trust domain and a software module other than a trust domain management module can receive hypercalls made by an L2 virtual I/O device driver containing information indicating a memory operation involving a virtual I/O device and pass along this information to an L0 hypervisor to determine the software response of the L2 virtual I/O device. This software module could be an L1 kernel or a software module within the L1 kernel, such as an L1 virtual machine monitor. It could also be the L0 hypervisor itself.

It is to be understood that FIG. 2 illustrates one example of a set of modules that can be included in a computing environment. In other embodiments, a computing environment can have more or fewer modules than those shown in FIG. 2. The modules shown in FIG. 2 can be implemented in software, hardware, firmware, or combinations thereof. A computer system referred to as being programmed to perform a method can be programmed to perform the method via software, hardware, firmware, or combinations thereof.

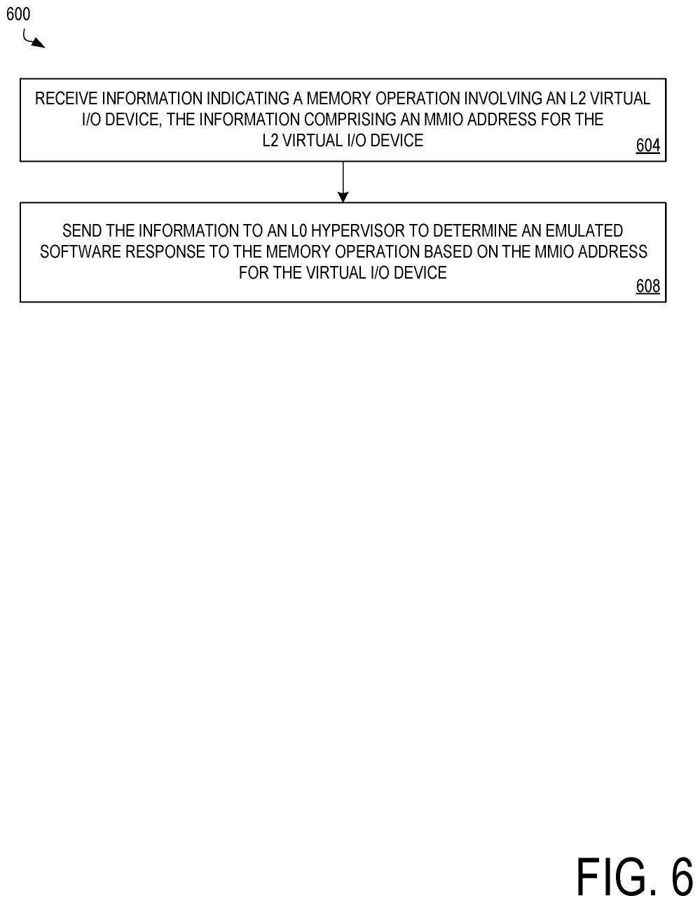

FIG. 6 is an example method of determining an emulated software response from an L2 MMIO address. The method 600 can be performed, for example, by a server computing system operating in a data center. At 604, a software module operating on a computing system receives information indicating a memory operation involving a virtual input/output (I/O) device, the information received from a level 2 (L2) virtual machine operating on a level 1 (L1) virtual machine operating on the computing system, the information comprising a memory-mapped I/O (MMIO) address for the virtual I/O device. At 608, the software module sends the information to a level 0 (L0) hypervisor operating on the computer device to determine the emulated software response from the MMIO address for the virtual I/O device.

In other embodiments, the method 600 can comprise one or more additional elements. For example, the method 600 can further comprise a virtual I/O device driver operating on the L2 virtual machine sending the information indicating the memory operation involving the virtual I/O device is performed by a virtual I/O device driver operating on the L2 virtual machine. In another example, the method 600 can further comprise sending the MMIO address from the L0 hypervisor to a second software module capable of emulating the software response based on the MMIO BAR address for the virtual I/O device as seen by the L2 virtual machine, the second software module operating in L0 user space; and determining, by the second software module, the emulated software response for the virtual I/O device. In yet another example, the method 600 can further comprise reading an MMIO base address register address for the virtual I/O device as seen by the L1 virtual machine; and storing the MMIO BAR address for the virtual I/O device as seen by the L1 virtual machine as an MMIO BAR address for the virtual I/O device as seen by the L2 virtual machine.

The technologies described herein can be performed by or implemented in any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment). As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies applications and data), and an edge data center (e.g., a data center, typically having a smaller footprint than other data center types, located close to the geographic area that it serves).

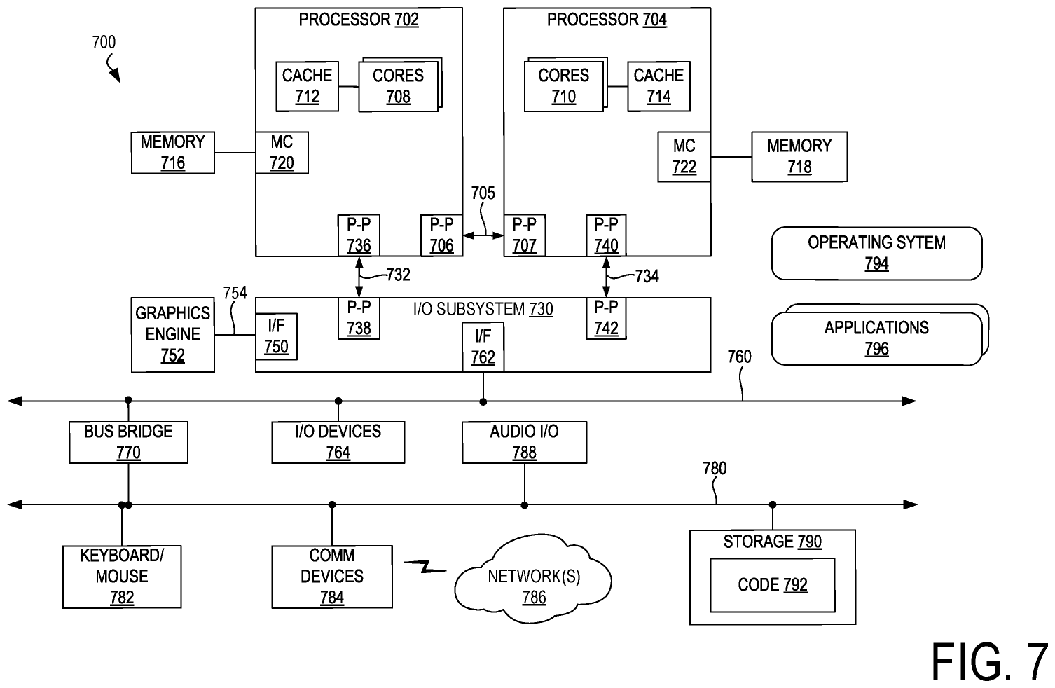

FIG. 7 is a block diagram of an example computing system in which technologies described herein may be implemented. Generally, components shown in FIG. 7 can communicate with other shown components, although not all connections are shown, for ease of illustration. The computing system 700 is a multiprocessor system comprising a first processor unit 702 and a second processor unit 704 comprising point-to-point (P-P) interconnects. A point-to-point (P-P) interface 706 of the processor unit 702 is coupled to a point-to-point interface 707 of the processor unit 704 via a point-to-point interconnection 705. It is to be understood that any or all of the point-to-point interconnects illustrated in FIG. 7 can be alternatively implemented as a multi-drop bus, and that any or all buses illustrated in FIG. 7 could be replaced by point-to-point interconnects.

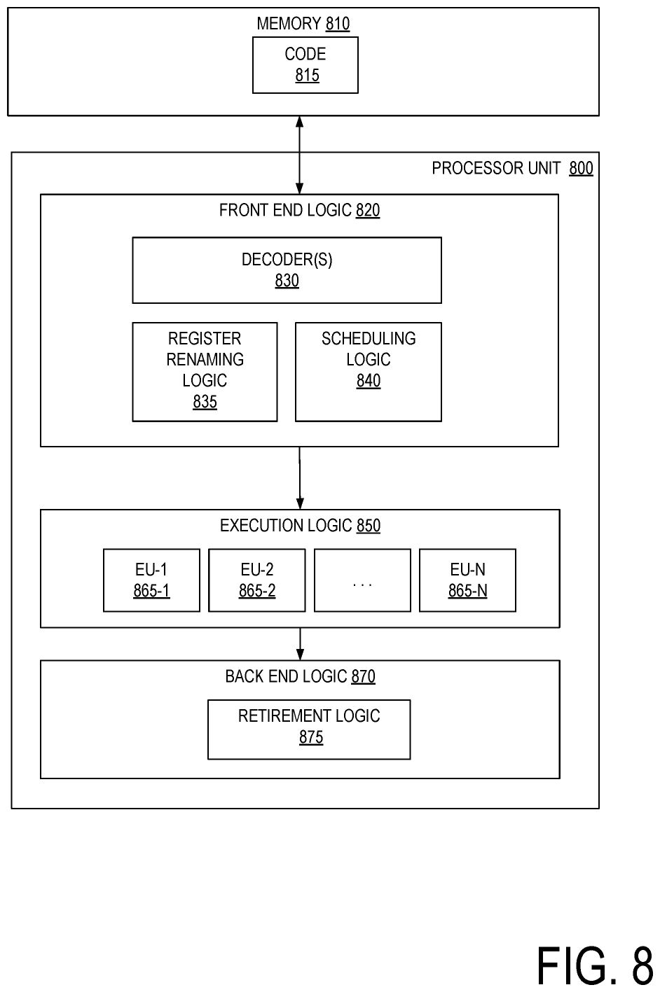

The processor units 702 and 704 comprise multiple processor cores. Processor unit 702 comprises processor cores 708 and processor unit 704 comprises processor cores 710. Processor cores 708 and 710 can execute computer-executable instructions in a manner similar to that discussed below in connection with FIG. 8, or other manners.

Processor units 702 and 704 further comprise cache memories 712 and 714, respectively. The cache memories 712 and 714 can store data (e.g., instructions) utilized by one or more components of the processor units 702 and 704, such as the processor cores 708 and 710. The cache memories 712 and 714 can be part of a memory hierarchy for the computing system 700. For example, the cache memories 712 can locally store data that is also stored in a memory 716 to allow for faster access to the data by the processor unit 702. In some embodiments, the cache memories 712 and 714 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 700 is shown with two processor units, the computing system 700 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 700 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 702 and 704 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 702 and 704 further comprise memory controller logic (MC) 720 and 722. As shown in FIG. 7, MCs 720 and 722 control memories 716 and 718 coupled to the processor units 702 and 704, respectively. The memories 716 and 718 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 720 and 722 are illustrated as being integrated into the processor units 702 and 704, in alternative embodiments, the MCs can be external to a processor unit.

Processor units 702 and 704 are coupled to an Input/Output (I/O) subsystem 730 via point-to-point interconnections 732 and 734. The point-to-point interconnection 732 connects a point-to-point interface 736 of the processor unit 702 with a point-to-point interface 738 of the I/O subsystem 730, and the point-to-point interconnection 734 connects a point-to-point interface 740 of the processor unit 704 with a point-to-point interface 742 of the I/O subsystem 730. Input/Output subsystem 730 further includes an interface 750 to couple the I/O subsystem 730 to a graphics engine 752. The I/O subsystem 730 and the graphics engine 752 are coupled via a bus 754.

The Input/Output subsystem 730 is further coupled to a first bus 760 via an interface 762. The first bus 760 can be a Peripheral Component Interconnect Express (PCIe) bus or any other type of bus. Various I/O devices 764 can be coupled to the first bus 760. A bus bridge 770 can couple the first bus 760 to a second bus 780. In some embodiments, the second bus 780 can be a low pin count (LPC) bus. Various devices can be coupled to the second bus 780 including, for example, a keyboard/mouse 782, audio I/O devices 788, and a storage device 790, such as a hard disk drive, solid-state drive, or another storage device for storing computer-executable instructions (code) 792 or data. The code 792 can comprise computer-executable instructions for performing methods described herein. Additional components that can be coupled to the second bus 780 include communication device(s) 784, which can provide for communication between the computing system 700 and one or more wired or wireless networks 786 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 702.11 standard and its supplements).

In embodiments where the communication devices 784 support wireless communication, the communication devices 784 can comprise wireless communication components coupled to one or more antennas to support communication between the computing system 700 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 700 can comprise removable memory such as flash memory cards (e.g., SD (Secure Digital) cards), memory sticks, Subscriber Identity Module (SIM) cards). The memory in system 700 (including caches 712 and 714, memories 716 and 718, and storage device 790) can store data and/or computer-executable instructions for executing an operating system 794 and application programs 796. Example data includes web pages, text messages, images, sound files, and video data to be sent to and/or received from one or more network servers or other devices by the system 700 via the one or more wired or wireless networks 786, or for use by the system 700. The system 700 can also have access to external memory or storage (not shown) such as external hard drives or cloud-based storage.

The operating system 794 can control the allocation and usage of the components illustrated in FIG. 7 and support the one or more application programs 796. The application programs 796 can include common computing system applications (e.g., email applications, calendars, contact managers, web browsers, messaging applications) as well as other computing applications.

In some embodiments, applications operating at the L0 level or on a virtual machine can operate within one or more containers. A container is a running instance of a container image, which is a package of binary images for one or more of the applications 796 and any libraries, configuration settings, and any other information that one or more applications 796 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 794. An orchestrator can be responsible for management of the computing system 700 and various container-related tasks such as deploying container images to the computing system 794, monitoring the performance of deployed containers, and monitoring the utilization of the resources of the computing system 794.

The computing system 700 can support various additional input devices, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to, or removably attachable with the system 700. External input and output devices can communicate with the system 700 via wired or wireless connections.

The system 700 can further include at least one input/output port comprising physical connectors (e.g., USB, IEEE 1394 (FireWire), Ethernet, RS-232) and a power supply (e.g., battery), The computing system 700 can further comprise one or more additional antennas coupled to one or more additional receivers, transmitters, and/or transceivers to enable additional functions.

It is to be understood that FIG. 7 illustrates only one example computing system architecture. Computing systems based on alternative architectures can be used to implement technologies described herein. For example, instead of the processors 702 and 704 and the graphics engine 752 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 7. Moreover, the illustrated components in FIG. 7 are not required or all-inclusive, as shown components can be removed and other components added in alternative embodiments.

FIG. 8 is a block diagram of an example processor unit 800 to execute computer-executable instructions as part of implementing technologies described herein. The processor unit 800 can be a single-threaded core or a multithreaded core in that it may include more than one hardware thread context (or “logical processor”) per processor unit.

FIG. 8 also illustrates a memory 810 coupled to the processor unit 800. The memory 810 can be any memory described herein or any other memory known to those of skill in the art. The memory 810 can store computer-executable instructions 815 (code) executable by the processor unit 800.

The processor unit comprises front-end logic 820 that receives instructions from the memory 810. An instruction can be processed by one or more decoders 830. The decoder 830 can generate as its output a micro-operation such as a fixed width micro-operation in a predefined format, or generate other instructions, microinstructions, or control signals, which reflect the original code instruction. The front-end logic 820 further comprises register renaming logic 835 and scheduling logic 840, which generally allocate resources and queues operations corresponding to converting an instruction for execution.

The processor unit 800 further comprises execution logic 850, which comprises one or more execution units (EUs) 865-1 through 865-N. Some processor unit embodiments can include a number of execution units dedicated to specific functions or sets of functions. Other embodiments can include only one execution unit or one execution unit that can perform a particular function. The execution logic 850 performs the operations specified by code instructions. After completion of execution of the operations specified by the code instructions, back-end logic 870 retires instructions using retirement logic 875. In some embodiments, the processor unit 800 allows out of order execution but requires in-order retirement of instructions. Retirement logic 875 can take a variety of forms as known to those of skill in the art (e.g., re-order buffers or the like).

The processor unit 800 is transformed during execution of instructions, at least in terms of the output generated by the decoder 830, hardware registers and tables utilized by the register renaming logic 835, and any registers (not shown) modified by the execution logic 850.

As used herein, the term “module” refers to logic that may be implemented in a hardware component or device, software or firmware running on a processor unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processor units, state machine circuitry, and/or firmware that stores instructions executable by programmable circuitry. Modules described herein may, collectively or individually, be embodied as circuitry that forms a part of a computing system. Thus, any of the modules can be implemented as circuitry.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a method comprising: receiving, by a software module operating on a computing system, information indicating a memory operation involving a virtual input/output (I/O) device, the information received from a level 2 (L2) virtual machine operating on a level 1 (L1) virtual machine operating on the computing system, the information comprising a memory-mapped I/O (MMIO) address for the virtual I/O device; and sending, by the software module, the information to a level 0 (L0) hypervisor operating on the computer system to determine an emulated software response to the memory operation based on the MMIO address for the virtual I/O device.

Example 2 comprises the method of Example 1, wherein the L2 virtual machine is a first L2 virtual machine, the first L2 virtual machine partitioned from a second L2 virtual machine operating on the L1 virtual machine.

Example 3 comprises the method of Example 1, wherein the L1 virtual machine and the L2 virtual machine are operating within a trust domain and the software module is a trust domain management module.

Example 4 comprises the method of Example 1, wherein the L1 virtual machine and the L2 virtual machine operate in in a reserved portion of memory of the computing system, contents of the reserved portion of memory are encrypted, the software module is to ensure that private memory accesses made by the L2 virtual machine are made to the reserved portion of memory, and the software module is stored in the reserved portion of memory.

Example 5 comprises the method of any one of Examples 1 and 3-4, further comprising a virtual I/O device driver operating on the L2 virtual machine sending the information indicating the memory operation involving the virtual I/O device.

Example 6 comprises the method of any one of Examples 1-5, wherein the information indicating the memory operation involving a virtual I/O device is part of a TDVMCALL operation.

Example 7 comprises the method of Example 1 or 5, wherein the software module is a virtual machine monitor operating on the L1 virtual machine.

Example 8 comprises the method of any one of Examples 1-6, wherein the software module is a first software module, the method further comprising: sending the MMIO address from the L0 hypervisor to a second software module capable of emulating the software response to the memory operation based on the MMIO address for the virtual I/O device, the second software module operating in L0 user space; and determining, by the second software module, the emulated software response to the memory operation based on the MMIO address.

Example 9 comprises the method of any one of Examples 1-8, wherein the memory operation is a read operation, the method further comprising: reading read data from the virtual I/O device; and returning the read data to the L2 virtual machine.

Example 10 comprises the method of any one of Examples 1-8, wherein the memory operation is a write operation and the information further comprises write data, the method further comprising writing the write data to the virtual I/O device.

Example 11 comprises the method of any one of Examples 1-10, wherein the MMIO address for the virtual I/O device is the MMIO address for the virtio I/O device as seen by the L2 virtual machine, the method further comprising, prior to startup of the L2 virtual machine: reading an MMIO BAR address for the virtual I/O device as seen by the L1 virtual machine; and storing the MMIO BAR address for the virtual I/O device as seen by the L1 virtual machine as the MMIO BAR address for the virtual I/O device as seen by the L2 virtual machine.

Example 12 comprises the method of Example 11, wherein reading the MMIO BAR address for the virtual I/O device as seen by the L2 virtual machine and storing the MMIO BAR address for the virtual I/O device as seen by the L1 virtual machine as the MMIO BAR address for the virtual I/O device as seen by the L2 virtual machine are performed by an emulator capable of emulating at least a portion of the virtual I/O device.

Example 13 comprises the method of Example 12, wherein the emulator is a Quick Emulator (QEMU) instance.

Example 14 comprises the method of Example 11, further comprising, during startup of the L2 virtual machine, not changing the MMIO BAR address for the virtual I/O device as seen by the L2 virtual machine.

Example 15 comprises the method of any one of Examples 1-14, wherein the virtual I/O device is passed through from the L1 virtual machine to the L2 virtual machine.

Example 16 comprises the method of any one of Examples 1-15, wherein the virtual I/O device is a virtio device.

Example 17 comprises the method of any one of Examples 1-16, wherein the virtual I/O device is compliant with the Peripheral Component Interconnect Express (PCIe) standard.

Example 18 is a computing system comprising: one or more processor units; and one or more computer-readable media storing instructions that, when executed, cause the one or more processor units to perform the method of any one of Examples 1-16.

Example 19 is one or more computer-readable storage media storing computer-executable instructions that, when executed, cause a computing device to perform the method of any one of Examples 1-16.

1. A method comprising:
receiving, by a software module operating on a computing system, information indicating a memory operation involving a virtual input/output (I/O) device, the information received from a level 2 (L2) virtual machine operating on a level 1 (L1) virtual machine operating on the computing system, the information comprising a memory-mapped I/O (MMIO) address for the virtual I/O device; and
sending, by the software module, the information to a level 0 (L0) hypervisor operating on the computer system to determine an emulated software response to the memory operation based on the MMIO address for the virtual I/O device.

2. The method of claim 1, wherein the L2 virtual machine is a first L2 virtual machine, the first L2 virtual machine partitioned from a second L2 virtual machine operating on the L1 virtual machine.

3. The method of claim 1, wherein the L1 virtual machine and the L2 virtual machine are operating within a trust domain and the software module is a trust domain management module.

4. The method of claim 1, further comprising a virtual I/O device driver operating on the L2 virtual machine sending the information indicating the memory operation involving the virtual I/O device.

5. The method of claim 1, wherein the software module is a virtual machine monitor operating on the L1 virtual machine.

6. The method of claim 1, wherein the software module is a first software module, the method further comprising:
sending the MMIO address from the L0 hypervisor to a second software module capable of determining a software response based on the MMIO address for the virtual I/O device, the second software module operating in L0 user space; and
determining, by the second software module, the software response based on the MMIO address for the virtual I/O device.

7. The method of claim 1, wherein the MMIO address for the virtual I/O device is the MMIO address for the virtual I/O device as seen by the L2 virtual machine, the method further comprising, prior to startup of the L2 virtual machine:
reading an MMIO BAR address for the virtual I/O device as seen by the L1 virtual machine; and
storing the MMIO BAR address for the virtual I/O device as seen by the L1 virtual machine as the MMIO BAR address for the virtual I/O device as seen by the L2 virtual machine.

8. The method of claim 7, further comprising, during startup of the L2 virtual machine, not changing the MMIO BAR address for the virtual I/O device as seen by the L2 virtual machine.

9. The method of claim 1, wherein the virtual I/O device is passed through from the L1 virtual machine to the L2 virtual machine.

10. A computing system comprising:
one or more processor units; and
one or more computer-readable media storing instructions that, when executed, cause the one or more processor units to:
receive information indicating a memory operation involving a virtual input/output (I/O) device, the information received from a level 2 (L2) virtual machine operating on a level 1 (L1) virtual machine operating on the computing system, the information comprising a memory-mapped I/O (MMIO) address for the virtual I/O device; and
send the information to a level 0 (L0) hypervisor operating on the computer system to determine an emulated software response based on the MMIO address for the virtual I/O device.

11. The computing system of claim 10, wherein the L2 virtual machine is a first L2 virtual machine, the first L2 virtual machine partitioned from a second L2 virtual machine operating on the L1 virtual machine.

12. The computing system of claim 10, wherein the L1 virtual machine and the L2 virtual machine are to operate within a trust domain.

13. The computing system of claim 10, wherein the instructions, when executed, are to further cause the one or more processor units to send, by a virtual I/O device driver operating on the L2 virtual machine, the information indicating the memory operation involving the virtual I/O device.

14. The computing system of claim 10, wherein the instructions, when executed, are to further cause the one or more processor units to:
send the MMIO address from the L0 hypervisor to a software module capable of determining an emulated software response based on the MMIO address for the virtual I/O device, the software module operating in L0 user space; and
determine, by the software module, the emulated software response based on the MMIO address for the virtual I/O device.

15. The computing system of claim 10, wherein the MMIO address for the virtual I/O device is the MMIO address for the virtual I/O device as seen by the L2 virtual machine, wherein the instructions, when executed, are to further cause the one or more processor units to, prior to startup of the L2 virtual machine:
read an MMIO BAR address for the virtual I/O device as seen by the L1 virtual machine; and
store the MMIO BAR address for the virtual I/O device as seen by the L1 virtual machine as the MMIO BAR address for the virtual I/O device as seen by the L2 virtual machine.

16. One or more computer-readable storage media storing computer-executable instructions that, when executed, cause a computing system to:
receive information indicating a memory operation involving a virtual input/output (I/O) device, the information received from a level 2 (L2) virtual machine operating on a level 1 (L1) virtual machine operating on the computing system, the information comprising a memory-mapped I/O (MMIO) address for the virtual I/O device; and
send the information to a level 0 (L0) hypervisor operating on the computer system to determine an emulated software response based on the MMIO address for the virtual I/O device.

17. The one or more computer-readable storage media of claim 16, wherein the L2 virtual machine is a first L2 virtual machine, the first L2 virtual machine partitioned from a second L2 virtual machine operating on the L1 virtual machine.

18. The one or more computer-readable storage media of claim 16, wherein the L1 virtual machine and the L2 virtual machine are operating within a trust domain.

19. The one or more computer-readable storage media of claim 16, wherein the instructions, when executed, are to further cause the computing system to send, by a virtual I/O device driver operating on the L2 virtual machine, the information indicating the memory operation involving the virtual I/O device.

20. The one or more computer-readable storage media of claim 16, wherein the instructions, when executed, are to further cause the computing system to:
send the MMIO address from the L0 hypervisor to a software module capable of determining an emulated software response based on the MMIO address for the virtual I/O device, the software module operating in L0 user space; and
determine, by the software module, the emulated software response based on the MMIO address for the virtual I/O device.
